(19) United States
(12) Patent Application Publication
(10) Pub. No.: US 2024/0368031 A1
(43) Pub. Date: Nov. 7, 2024

(54) METHOD OF MANUFACTURING FLEXIBLE COVER WINDOW AND FLEXIBLE COVER WINDOW MANUFACTURED USING SAME

(71) Applicants: UTI INC., Chungcheongnam-do (KR); Corning Incorporated, Corning, NY (US)

(72) Inventors: Deok Young PARK, Gyeonggi-do (KR); Jae Young HWANG, Gyeonggi-do (KR); Kukhyun SUNWOO, Gyeonggi-do (KR); Tea Joo HA, Chungcheongnam-do (KR)

(73) Assignees: UTI INC., Chungcheongnam-do (KR); Corning Incorporated, Corning, NY (US)

(21) Appl. No.: 18/772,914

(22) Filed: Jul. 15, 2024

Related U.S. Application Data
(63) Continuation of application No. 17/552,950, filed on Dec. 16, 2021.

(30) Foreign Application Priority Data
Dec. 18, 2020 (KR) 10-2020-0178950

(51) Int. Cl. C03C 21/00; G06F 1/16

(52) U.S. Cl. CPC C03C 21/002; G06F 1/1652; C03C 2204/00

(57) ABSTRACT

Proposed is a flexible cover window manufacturing method capable of simultaneously reinforcing a plane part and a folding part by using alkali-based metal ions having an ionic radius smaller than that of alkali-based metal ions contained in a glass. A flexible cover window manufactured using the same method is also proposed. The plane part and the folding part are simultaneously reinforced using alkali-based metal ions having a smaller ionic radius than alkali-based metal ions included in a glass to simplify the process, and the flexible cover window ensures strength and folding characteristics by controlling tensile stress of the entire part of the flexible cover window.

### CROSS REFERENCE TO RELATED APPLICATIONS

The present application is a continuation of U.S. patent application Ser. No. 17/552,950 filed Dec. 16, 2021 and entitled “Method Of Manufacturing Flexible Cover Window and Flexible Cover Window Manufacture Using Same,” and which claims priority to Korean Patent Application No. 10-2020-0178950, filed Dec. 18, 2020, the entire contents of each of which are incorporated herein for all purposes by this reference.

### FIELD

The present disclosure relates to a manufacturing method for a glass-based cover window and a flexible cover window manufactured using the same. The present disclosure relates to a flexible cover window manufacturing method capable of simultaneously reinforcing a plane part and a folding part by using alkali-based metal ions having a smaller ion radius than alkali-based metal ions included in glass, and a flexible cover window manufactured through the same method.

### TECHNICAL BACKGROUND

In recent years, electrical and electronic technologies are rapidly developing, and various types of display products are emerging to meet the needs of the new era and the needs of various consumers.

In the case of a flexible display, research is basically being conducted on displays in the form bending, rolling, and stretching starting from folding. A cover window for protecting the display panel as well as the display panel should be formed to be flexible.

Such a flexible cover window should have good flexibility and should not cause marks on the folding part even when repeatedly being folded, and there should be no distortion of image quality.

For the cover window of the existing flexible display, a polymer film such as PI or PET has been used on the surface of the display panel.

However, in the case of a polymer film, due to its weak mechanical strength, it simply serves to prevent scratches on a display panel, is vulnerable to impact resistance, has low transmittance, and is known to be relatively expensive.

In addition, in the case of such a polymer film, as the number of folds of the display increases, marks are left on the folding part, resulting in damage to the folding part. For example, pressing or tearing of the polymer film occurs during the evaluation of the folding limit (normally 200,000 times).

Recently, in order to overcome the limitations of the cover window of the polymer film, various studies on glass-based cover windows have been conducted.

In the case of a glass-based cover window, there is a need for basic required physical properties that satisfy folding characteristics, have no distortion of the screen, have sufficient strength even in repeated contact such as by a touch pen, and a certain pressure.

In order to satisfy the strength characteristics of the cover window, the glass should be a certain thickness or more, and to satisfy the folding characteristics, the glass should be less than a certain thickness. In addition, there is a need for research on the optimal cover window thickness and structure without distortion of the screen.

According to the related art, there are many technologies in which a glass is formed to satisfy the folding characteristics and strength characteristics, and a folding area (folding part) of a cover window is formed to be relatively slimmer than other areas (plane part).

In order to reinforce the strength of such a cover window, a chemical reinforcement method is mainly used. In the chemical reinforcement, when an alkali-based glass is immersed in a high-temperature KNO₃ molten salt, compressive stress is generated on the glass surface due to the substitution of K ions in the molten salt and Na ions in the glass. At this time, the volume of the glass increases due to the influence of K ions having a large atomic size.

In particular, when the folding part is formed to be slim, the natural explosion, breakage, or waviness of the cover window may occur due to the high compression ratio in the folding part due to the imbalance of tensile stress according to the thickness, which will seriously affect the quality of the product.

FIGS. 1A and 1B illustrate an imbalance of tensile stress due to a difference in thickness between a folding part and a plane part in a conventional flexible cover window. As shown, a phenomenon in which the thin plane part is more increased, resulting in deterioration of the overall quality of the cover window.

In order to solve this problem, a method of adjusting the degree of reinforcement between the folding part and the plane part has been tried, but it is difficult to secure uniformity of reinforcement on the entire cover window. Non-uniformity problems of compressive stress (CS) and reinforcement depth (DOL) remain for each cover window position.

### SUMMARY

The present disclosure has been derived from the above necessity, and the objective of the present disclosure is to provide a method for manufacturing a flexible cover window for simultaneously reinforcing a plane part and a folding part using alkali-based metal ions having an ion radius smaller than that of alkali-based metal ions included in glass, and the flexible cover window using the same.

In order to achieve the above objective, the present disclosure provides a method for manufacturing a flexible cover window for simultaneously reinforcing a plane part and a folding part using an alkali-based metal ion having an ionic radius smaller than that of the alkali-based metal ion contained in glass, and a flexible cover window manufactured thereby.

In addition, the alkali-based metal ion having a smaller ionic radius than that of the alkali-based metal ion contained in the glass is preferably lithium.

In addition, the manufacturing method of the flexible cover window is preferably performed using a molten salt containing potassium ions and lithium ions.

Moreover, the said molten salt contains KNO₃, NaNO₃, and LiNO₃ preferably.

In addition, according to the method of manufacturing the flexible cover window, a first reinforcing process may be performed by using a molten salt including potassium ions and lithium ions, and then a second reinforcing process may be performed by using a molten salt including potassium ions.

In addition, the molten salt used in the first reinforcing process contains KNO₃, NaNO₃, and LiNO₃ preferably.

In addition, KNO₃ should be contained in an amount of 20 to 70 parts by weight and LiNO₃ in an amount of 0.1 to 5 parts by weight based on the total molten salt.

In addition, the molten salt used in the second reinforcing process preferably includes any one or both of LiNO₃ and NaNO₃ while including KNO₃.

In addition, the amount of LiNO₃ is preferably equal to or less than that in the first reinforcing process.

In addition, the amount of LiNO₃ is preferably contained in an amount of 0.1 to 2 parts by weight based on the total molten salt.

The present disclosure relates to a glass-based cover window. In particular, the present disclosure provides a flexible cover window that maintains a reinforced glass-specific texture while simultaneously reinforcing a plane part and a folding part using alkali-based metal ions having a smaller ionic radius than alkali-based metal ions included in glass to simplify a process. A flexible cover window in which strength and folding characteristics are secured is provided by adjusting the tensile stress of the entire area.

In particular, the present disclosure provides to prevent deformation, bending, and breakage due to a difference in tensile stress of a glass substrate after reinforcement due to a difference in thickness between a plane part and a folding part. By performing the chemical reinforcement process using metal ions, there is no need for an additional process such as a masking process in the existing partial chemical reinforcing process, thereby improving mass productivity.

Accordingly, by simultaneously chemically reinforcing the plane part and the folding part, problems of reinforcement non-uniformity such as dispersion and precision coating of the coating solution, which is a conventional partial chemical reinforcement process, and deviation of the upper and lower ends due to the stagnant phenomenon of the coating solutions, are completely solved. Since the masking process is not performed, the process may be simply performed.

### BRIEF DESCRIPTION OF THE DRAWINGS

FIGS. 1A and 1B are views showing a photograph of a flexible cover window according to the related art;

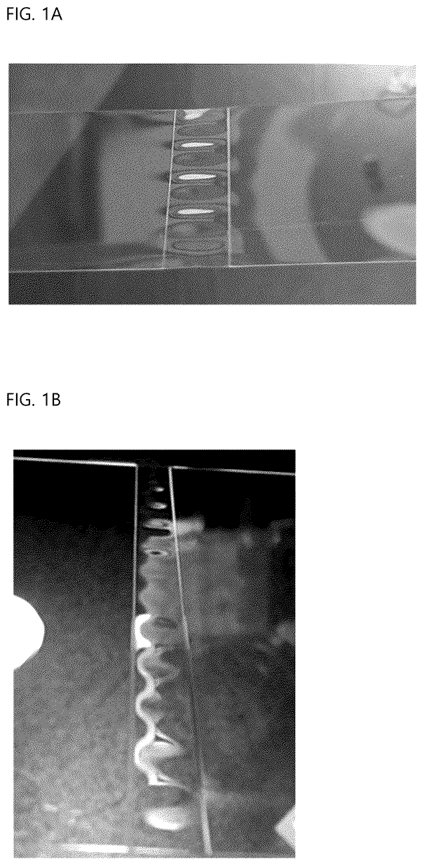

FIGS. 2 and 3 are schematic diagrams for explaining the principle of the present disclosure; and

FIG. 4 is a view showing a photograph of a flexible cover window according to the present disclosure.

### DETAILED DESCRIPTION

The present disclosure relates to a glass-based cover window. In particular, the present disclosure provides a flexible cover window that maintains a reinforced glass-specific texture, simultaneously reinforcing a plane part and a folding part using alkali-based metal ions having a smaller ionic radius than alkali-based metal ions included in glass to simplify a process. A flexible cover window in which strength and folding characteristics are secured is provided by adjusting the tensile stress of the entire area.

In particular, the present disclosure provides a flexible cover window to prevent deformation, bending, and breakage due to a difference in tensile stress of a glass substrate after reinforcement due to a difference in thickness between a plane part and a folding part. By performing the chemical reinforcement process using metal ions, there is no need for an additional process such as a masking process in the existing partial chemical reinforcement process, thereby improving mass productivity.

Accordingly, by simultaneously chemically reinforcing the plane part and the folding part, problems of reinforcement non-uniformity such as dispersion and precision coating of the coating solution, which is a conventional partial chemical reinforcement process, and deviation of the upper and lower ends due to the stagnant phenomenon of the coating solutions, are completely solved. Since the masking process is not performed, the process may be simply performed.

The present disclosure relates to a method for manufacturing a flexible cover window for simultaneously reinforcing a plane part and a folding part using an alkali metal ion having a smaller ionic radius than an alkali metal ion contained in glass, and a flexible cover window manufactured using the same.

In the present disclosure, the term “front surface” means a surface that a user may touch, which means a surface that a touch pen or the like comes into contact with, and means a surface in an upward direction in the drawings. In the present disclosure, the “rear surface” is a surface opposite to the front surface and means a surface opposite to the touch, that is, a surface in a direction toward the display panel, and a surface in a downward direction in the drawing.

In the present disclosure, the “folding area” of the display refers to an area in which the display is folded or bent in half, and the area in which the cover window is folded corresponding to this area is referred to as the “folding part” (F) of the cover window in the present disclosure. The flat area excluding the folding part (F) is referred to as the “plane part” (P) of the cover window.

In particular, the present disclosure is formed on a glass-based substrate, and the glass substrate 100 is formed entirely flat (the thickness of the folding part (F) and the plane part (P) are the same), or the folding part (F) is segmented into one or more sections. Accordingly, the glass substrate 100 may be formed into two-piece, three-piece, or the like as a whole.

In addition, the folding part (F) may be formed by slimming to have a thinner thickness than the plane part (P). Generally, the thickness of the plane part (P) of the cover window is 30 to 300 μm, and the thickness of the folding part (F) is about 10 to 100 μm, and the folding part (F) is formed by processing a very thin glass plate.

Here, the folding part (F) may have a uniform thickness or may be formed to gradually increase in thickness from the center of the folding area toward the outside. That is, the cross-section of the folding part (F) may be formed in a straight-line or curved shape.

When the folding part (F) is formed in a straight-line shape, folding characteristics are further improved compared to the technology formed in a curved shape. If the folding part (F) has a curved shape, a range of the minimum thickness is relatively small, and when the folding is repeated, the folding characteristics such as breakage when folding in the thick part are degraded. When the folding part (F) has a uniform thickness as a whole, that is, when the folding part is formed in a straight-line shape having the same thickness, a region constituting the minimum thickness is formed widely to improve flexibility, restoring force, and elastic force, thereby improving folding characteristics.

In addition, it is not easy to align the center part of the curved folding part (F) when assembling mechanically, but the folding part (F), according to the present disclosure, has a uniform thickness. It is possible to reduce assembly tolerance when assembling, that is, when bonding to the front of the display panel, thereby minimizing differences in quality between products and reducing the defect rate.

As described above, the advantages of the straight-line shaped folding part (F) are more than the advantages of the curved shape folding part (F), but it may be manufactured by selecting the straight-line shaped folding part (F) or the curved shape folding part (F) according to the specifications of the product.

Here, the width of the folding part (F) is designed in consideration of the radius of curvature when the cover window is folded and is approximately set to the radius of curvature×π. The thickness of the cover window in the folding part (F) is formed of 10 to 100 μm, which is related to the folding part (F).

If the depth of the folding part F is too deep, that is, if the folding area of the cover window is too thin, foldability is good, but wrinkles or strength are disadvantageous during reinforcement process. When the folding area of the cover window is too thick, flexibility, restoring force, and elastic force in the folding area are degraded, and thus, the thickness of the cover window in the folding part (F) may be appropriately about 10 to 100 μm.

The cover window in the present disclosure is formed with a thickness of about 30 to 300 μm based on glass and is chemically reinforced and used. In this thickness, the width and depth of the folding part (F) are appropriately designed as described above. If the cover window is thinner than the thickness described above, the thickness of the folding area of the cover window becomes too thin after the folding part (F) formation, and thus the above problems occur. Even if the cover window is thicker than the thickness described above, the flexibility, resilience, and elasticity are reduced based on the glass described above, and the weight reduction of the display product is hindered.

According to an embodiment of the present disclosure, the folding part (F) is formed in a shape in which the folding part (F) of the cover window is slimmed inward and is generally formed in a rectangular trench shape. An inclined part with a thickness gradually thickening in the folding part (F) may be formed at both side ends of the folding part (F) so as to be connected to a plane part (P) of the cover window.

In particular, by forming inclined parts with a low slope at both ends (a boundary part with the plane part (P)) of the folding part (F), the size of the reflection angle by the reflection surface is similarly adjusted in the entire region of the folding part (F), hence minimizing the interference of light and visual visibility on the reflection surface.

In addition, etching patterns may be formed on the folding part (F) and the plane part (P) or the folding part (F) in order to improve strength and folding characteristics on the glass substrate 100.

In this present disclosure, the cover window is formed on the front surface of the display panel to protect the display panel by maintaining folding and strength characteristics and may be disposed on a Clear Polyimide (CPI) cover to protect the CPI cover.

As described above, the present disclosure is to provide a flexible cover window that is formed on a glass-based and has a folding part (F) that is a thin plate and has reinforced strength and folding characteristics so as to be applied to a flexible display, and a glass substrate 100 constituting the flexible cover window may be integrally formed to have the same thickness in the entire region, or a slimming portion having a thinner thickness than that of the plane part (P) may be formed.

First, in the method for manufacturing a flexible cover window, according to the present disclosure, the folding part (F) is formed on one or both surfaces of a glass substrate.

A photoresist layer is formed on the glass substrate to form the folding part (F), and the resist layer is patterned to form a resist pattern layer having an open region for forming the folding part (F) on the glass substrate.

The photoresist layer is formed by laminating a photoresist coating, or dry film resist (DFR) on the glass substrate and patterning the resist layer to form a resist pattern layer for forming the folding part (F) on the glass substrate. After that, the folding part (F) is formed using the resist pattern layer as a mask.

The folding part (F) may be formed using the pattern layer as a mask by at least one or a combination of two or more of the masking processes using wet etching, polishing, laser forming, masking ink, or dry film photoresist (DFR), or by the masking processes using such as wet etching, laser forming as a post-process.

In an embodiment of the present disclosure, after laminating DFR on the glass substrate, wet etching is performed using the DFR as a wet mask to form the folding part (F). Here, the inclined part of the folding part (F) is formed while the etching solution penetrates between the DFR and the glass substrate due to the lifting of the end of the folding part (F) side of the DFR.

According to the shape of the designed folding part, the slope of the inclined part or the length of the effective area of the inclined part, process conditions such as the thickness of the DFR, the degree of the lifting of the DFR at the end of the folding part (F), the concentration of the etchant, the temperature, and the etching time are adjusted.

The effective area (L) of the inclined part is determined according to the inclination of the inclined part, and about 50 to 5000 μm is suitable. In this case, the inclination (A) of the inclined part preferably has a slope of 1 to 20° with respect to the plane part (P).

The inclination of the inclined portion is to minimize the visibility of the boundary part due to light reflection. That is, when there is no inclination of the inclined part (boundary) (90°), the reflective surface at the boundary is visually recognized by the plane part (P) side reflection, thereby reducing distortion or resolution of the screen. In the present disclosure, the folding part (F) and the plane part (P) are connected at a gentle slope to minimize the visibility of the boundary part.

As described above, the present disclosure provides to simultaneously reinforce the plane part and the folding part by using an alkali-based metal ion having an ionic radius smaller than that of the alkali-based metal ion contained in the glass substrate on which the folding part is formed.

According to the present disclosure, alkali-based metals used in the chemical reinforcing process are shown in Table 1 below.

TABLE 1

| Division | Li | Na | K |
|---|---|---|---|
| Atomic number | 3 | 11 | 19 |
| Atomic weight(u) | 6.941 | 22.989769 | 39.0983 |
| Atomic weight(g) | 1.15E−23 | 3.82E−23 | 6.49E−23 |
| Melting point (° C.) | 180.5 | 97.79 | 63.5 |
| Atomic radius (pm) | 152 | 190 | 243 |
| | 0.8 times | | 1.28 times |
| | sodium | | sodium |

When alkali glass is immersed in high-temperature KNO₃ molten salt, compressive stress is generated on the surface of the glass due to the replacement of K ions in the molten salt with Na ions in the glass.

At this time, the volume of the glass increases due to the influence of K ions having a large atomic size. On the other hand, in the case of Li ions, since the atomic radius is smaller than that of Na ions of the glass, the volume of the glass is reduced.

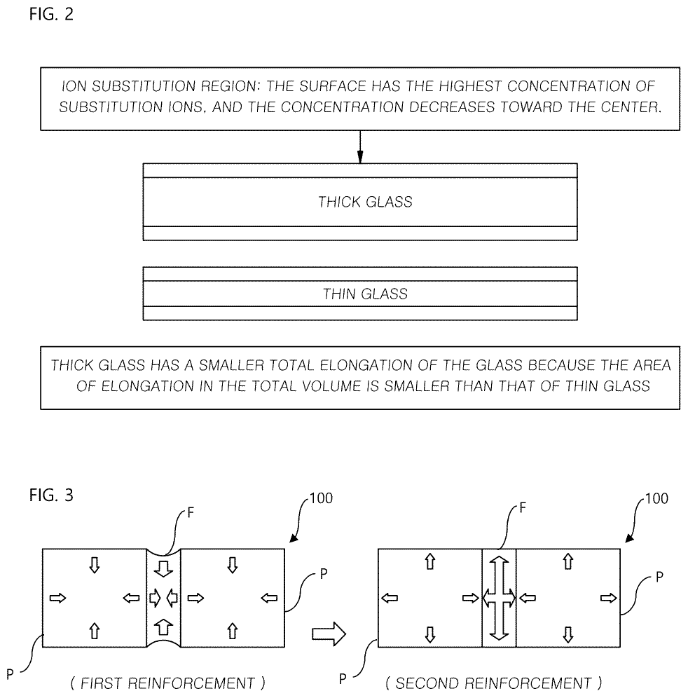

This feature is particularly conspicuous in the case of thin glass, which may be summarized as shown in Table 2 below. This is shown in FIG. 2.

TABLE 2

| Division | Thick glass | Thin glass |
|---|---|---|
| K | Small stretched | Greatly stretched |
| Li | Small reduced | Greatly reduced |

Tables 3 and 4 below measure the amount of change in length for each glass thickness in accordance with the amount of lithium added when lithium is not added to the molten salt and when lithium is added.

TABLE 3
Li-free

| | |
|---|---|
| Experimental | Glass thickness |

| conditions | 40 um | 100 um |
|---|---|---|
| Condition A | 0.089 | 0.034 |
| Condition B | 0.110 | 0.048 |
| Condition C | 0.130 | 0.053 |
| Condition D | 0.151 | 0.061 |

TABLE 4
Li addition

| | |
|---|---|
| Experimental | Glass thickness |

| conditions | 40 um | 100 um |
|---|---|---|
| Condition A | −0.115 | −0.049 |
| Condition B | −0.153 | −0.056 |

Referred embodiments of the present disclosure are as follows.

### 1) Method 1: Two-Step Reinforcement Method

A. First reinforcement (KNO₃+NaNO₃+LiNO₃)
   a. Control CS/DOL by setting KNO₃ to 20% to 70%
   b. LiNO₃ is added 0.10% to 5% to reduce the glass.
   c. Reinforcing temperature is 350° C. to 460° C. and the time is 5 min˜10 hr.
B. Secondary reinforcement (Table 5)

TABLE 5

| Reinforcing liquid type | Temperature | Time |
|---|---|---|
| KNO₃ 100% | 350° C. to 460° C. | 1 minute to 1 hour |
| KNO₃ (98% to 99.9%) + | | |
| LiNO₃ (0.1% to 2%) | | |
| KNO₃ + NaNO₃ | | |
| KNO₃ + NaNO₃ + LiNO₃ | | |
| (0.1% to 2%) | | |

### 2) Method 2: One-Step Reinforcement Method

A. KNO₃ 100%+LiNO₃(0.1% to 5%)
B. KNO₃50% to 99%+NaNO₃ 1% to 50%+LiNO₃ 0.1% to 5%
※ The function of offsetting the length increase that occurs during K ion substitution through Li ion substitution (the amount of K ion substitution may be increased as the Li content increases)

A principle according to an embodiment of the present disclosure is illustrated in FIG. 3.

As a whole, the stretched portion and the reduced portion are offset to reinforce the folding part (F) and the plane part (P) simultaneously, and the tensile stress of the entire area of the flexible cover window is adjusted to provide a flexible cover window secured strength and folding characteristics.

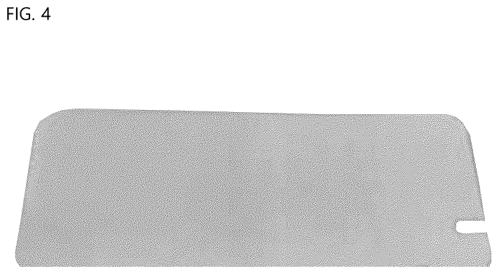

FIG. 4 shows a photograph of a flexible cover window manufactured according to an embodiment of the present disclosure. It was confirmed that deformation or bending, as in the related art, was minimized in the entire area of the folding part and the plane part.

As described above, the present disclosure is to prevent deformation, bending, and breakage due to a difference in tensile stress of a glass substrate after reinforcement due to a difference in thickness between a plane part and a folding part. By performing the chemical reinforcement process using metal ions, there is no need for an additional process such as a masking process in the existing partial chemical reinforcement process, thereby improving mass productivity.

Accordingly, by simultaneously chemically reinforcing the plane part and the folding part, problems of reinforcement non-uniformity such as dispersion and precision coating of the coating solution, which is a conventional partial chemical reinforcement process, and deviation of the upper and lower ends due to the stagnant phenomenon of the coating solutions, are completely solved. Since the masking process is not performed, the process may be simply performed.

What is claimed is:

1. A flexible cover window, comprising:
a plane part that comprises a thick glass,
wherein thickness of the thick glass is in a range of about 30 μm to about 300 μm;
wherein the plane part comprises larger alkali-based metal ions; and
wherein the larger alkali-based metal ions have a first radius;
a folding part segmenting the plane part into sections, wherein the folding part comprises a thin glass, slimmer than the thick glass;
wherein the folding part comprises the larger alkali-based metal ions; and
wherein thickness of the thin glass is in a range of about 10 μm to about 100 m; and
inclined parts on both sides of the folding part, gradually thickening and connecting the folding part to the sections of the plane part;
wherein the plane part and the folding part are reinforced with smaller alkali-based metal ions having a smaller radius than the first radius, thereby mitigating deformation, bending, and/or breakage due to a difference in tensile stress after reinforcement corresponding to difference in thickness between the plane part and the folding part.

2. The flexible cover window of claim 1, wherein the smaller alkali-based metal ions having the smaller radius are lithium.

3. The flexible cover window of claim 2, wherein the larger alkali-based metal ions having the first radius are sodium.

4. The flexible cover window of claim 1, wherein a cross-section of the folding part comprises a straight-line shape or curved shape.

5. The flexible cover window of claim 4, wherein the folding part has a uniform thickness as a whole, formed in the straight-line shape with substantially the same thickness.

6. The flexible cover window of claim 1, wherein the inclined parts comprise a low slope at both ends of the folding part.

7. The flexible cover window of claim 6, wherein the inclined parts have a slope in a range of 1° to 20° with respect to the plane part.

8. The flexible cover window of claim 1, wherein inclinations of the inclined parts are in a range of about 50 μm to about 5000 μm in distance.

9. The flexible cover window of claim 1, wherein the folding part is slimmed inward forming a trench shape from one or both surfaces of the flexible cover window.

10. The flexible cover window of claim 9, wherein the folding part is slimmed inward forming the trench shape from only one surface.

11. A flexible cover window, comprising:
a plane part that comprises a thick glass, wherein thickness of the thick glass is in a range of about 30 m to about 300 m,
wherein the plane part comprises larger alkali-based metal ions,
wherein the larger alkali-based metal ions have a first radius, and
wherein the first radius is about 190 μm;
a folding part segmenting the plane part into sections, wherein the folding part comprises a thin glass, slimmer than the thick glass of the plane part,
wherein the folding part also comprises the larger alkali-based metal ions;
wherein thickness of the thin glass is in a range of about 10 μm to about 100 m, and
wherein the folding part has a uniform thickness as a whole, formed in a straight-line shape with same thickness, thereby improving flexibility, restoring force, and elastic force; and
inclined parts on both sides of the folding part, gradually thickening and connecting to the sections of the plane part;
wherein the plane part and the folding part are reinforced with smaller alkali-based metal ions having a smaller radius than the first radius.

12. The flexible cover window of claim 11, wherein the smaller radius is about 152 μm.

13. The flexible cover window of claim 11, wherein the inclined parts have a slope in a range of about 1° to about 200 with respect to the plane part.

14. The flexible cover window of claim 11, wherein inclinations of the inclined parts are in a range of about 50 μm to about 5000 μm in distance.

15. The flexible cover window of claim 11, wherein the folding part is slimmed inward forming a trench shape from only one surface of the flexible cover window.

16. A flexible cover window, comprising:
a plane part that comprises a thick glass, wherein thickness of the thick glass is in a range of about 30 m to about 300 m;
wherein the plane part comprises larger alkali-based metal ions; and
wherein the larger alkali-based metal ions have a first radius;
a folding part segmenting the plane part into sections, wherein the folding part comprises a thin glass, slimmer than the thick glass of the plane part;
wherein the folding part also comprises the larger alkali-based metal ions;
wherein thickness of the thin glass is in a range of about 10 μm to about 100 m; and
wherein the folding part has a uniform thickness as a whole, formed in a straight-line shape with same thickness; and
inclined parts on both sides of the folding part, gradually thickening and connecting to the sections of the plane part;
wherein the inclined parts comprise a low slope at both ends of the folding part thereby controlling visibility of a boundary corresponding to the inclined parts;
wherein inclination of the inclined parts comprise a slope in a range of about 1° to about 200 with respect to the plane part; and
wherein inclinations of the inclined parts are in a range of about 50 μm to about 5000 μm in distance.

17. The flexible cover window of claim 16, wherein the folding part is slimmed inward forming a trench shape from only one surface of the flexible cover window.

18. The flexible cover window of claim 16, wherein the plane part and the folding part are reinforced with smaller alkali-based metal ions having a smaller radius than the first radius.

19. The flexible cover window of claim 18, wherein the smaller alkali-based metal ions having the smaller radius is lithium.

20. The flexible cover window of claim 19, wherein the larger alkali-based metal ions are sodium.
